(19) United States
(12) Patent Application Publication
(10) Pub. No.: US 2020/0370639 A1
(43) Pub. Date: Nov. 26, 2020

(54) Shifter Assembly For Controlling The Transmission Of A Motor Vehicle

(71) Applicant: KA Group AG, Zürich (CH)

(72) Inventors: Ingemar Emricson, Bankeryd (SE); David Blank, Mullsjö (SE); Andreas Kammensjö, Bankeryd (SE)

(21) Appl. No.: 16/968,948

(22) PCT Filed: Feb. 14, 2018
(86) PCT No.: PCT/EP2018/053626

§ 371 Date: Aug. 11, 2020

(51) Int. Cl. F16H 59/10; F16H 61/22; F16H 61/32

(52) U.S. Cl. CPC F16H 59/10; F16H 2059/081; F16H 61/32; F16H 61/22

(57) ABSTRACT

The invention is directed to a shifter assembly (1) for controlling the transmission of a vehicle. A rotatably mounted actuation element (2) with a locking track is rotatable for selection of a shift stage and at least one locking assembly (8, 9) with a rotatable locking member (13) may lock the actuation element (2) against rotation. The locking track is provided on the circumference of a ratchet wheel (4, 5) connected to the actuation element (2), and the locking assembly (8,9) includes a biasing member (12) applied to the locking member (13) to rotationally bias the locking member (13) such as to engage and lock the ratchet wheel. An electrically activated retaining device (11) is configured to retain the locking member (13) in a position such that the locking member (13) is prevented from rotating and engaging the ratchet wheel (4, 5) under the force of the biasing member (12).

The invention relates to a shifter assembly for controlling the transmission of a motor vehicle comprising a rotatably mounted actuation element that is rotatable for selection of a shift stage, and at least one locking assembly configured to lock the actuation element against rotation. The actuation element is provided with a locking track having a plurality of locking projections and the locking assembly includes at least one locking member. The locking member is rotatable about a rotational axis between a first position in which the locking member engages the locking track such as to lock the actuation element against rotation in at least one rotational direction and a second position in which rotation of the actuation element in the one rotational direction is allowed.

Within the field of motor vehicles, a shifter is generally used to allow a driver to manually select a gear or state of a transmission. The shifter is connected to the transmission in such a way that the selection made is allowed to determine the operation of the transmission and thus control the operation of the vehicle. The shifter itself can be of different designs and is often in the form of a gear shift lever that can be moved along a path between different positions corresponding to gears or modes of transmission. If a rotatable shifter, such as a rotatable knob, is used the actuation element is rotated between different angular positions, corresponding to gears or modes of transmission, such as Park (P), Reverse (R), Neutral (N) and Drive (D). Such rotatable shifters have become popular in shift-by-wire (SBW) configurations in which electrical signals are sent to a transmission depending on the rotated position of the shifter.

If the actuation element can rotate 360°, the shifter has the advantage that a particular angular position of the actuation element does not need to be linked to a particular state or mode of the transmission. Rather, a control unit arranged in communication with the shifter may determine the current position of the actuation element and decide which state of transmission this position should correspond to at the present time. This is particularly advantageous in a situation where the driver has switched off the ignition and left the car with the shifter in the Drive position and the vehicle automatically engages the Park position. When the driver returns to the vehicle and switches the ignition on, the control unit can detect the current position of the actuation element and determine that it should now be assigned to the Park (P) position. The remaining states of transmission can then be reassigned to the other angular positions of the actuation element to reflect this decision.

Depending on the chosen shift stage or the driving situation, rotation of the actuation element in clockwise or counter-clockwise direction is to be limited or prevented. For example, normally, the Park (P) position is considered as an end position of a shifting gate, leaving the driver only the possibility to move actuation element in one direction, e.g., toward the Reverse (R) gear. In other situations, it is desirable that the rotation of the shifter is prevented completely, e.g., for safety reasons.

EP 3 115 647 A2 describes a shifter assembly in accordance with the introductory part of claim 1. The shifter assembly is part of a vehicle transmission that performs a dial type gear shift operation. The vehicle transmission includes a knob that is rotated to select a shift stage. A rotatably mounted actuation element is connected to the knob, and a locking mechanism is provided to lock the actuation element against rotation.

For that purpose, the actuation element is provided with a locking track in the form of a plurality of fixing grooves with locking projections therebetween. A locking assembly interacting with the locking track includes a lever-like locking member that is rotatable about a rotational axis and which is driven by a linearly moving rod of a drive unit. The locking member has a first arm that extends from the rotational axis of the locking member and a second arm that extends from the rotational axis oblique to the first arm. The second arm has a locking pawl at its end for engaging the fixing grooves. The first arm is driven by the moving rod so that the second arm swivels about the pivot axis. By the swiveling motion of the locking member, the locking pawl is moved between a first rotational position, in which the locking pawl engages a fixing groove of the locking track and the actuation element is locked against rotation, and a second rotational position in which the locking pawl is disengaged from the locking track and the actuation element is free to rotate. The drive unit to rotate the locking member includes a moving rod that may reciprocate linearly, a coil and a magnet. A spring is provided between the moving rod and the magnet to elastically support the moving rod. The magnet is configured to retain moving rod in position when the supply of power to the coil is stopped. The locking unit requires power supply for bringing the locking member into and out of engagement with the actuation element, which is power consuming and considerably slow.

It is an object of the invention to provide a shifter assembly that is efficient in terms of power consumption and that provides fast actuation times and low operational noise.

The object of the invention is solved by a shifter assembly as defined in claim 1. Preferred embodiments of the invention are set out in the dependent claims.

According to the invention, the locking track is provided on the circumference of a ratchet wheel connected to the actuation element (e.g., attached to the actuation element or formed thereon). The locking assembly includes a biasing member applied to the locking member to rotationally bias the locking member into the first position, i.e., into engagement with the ratchet wheel. The locking member is formed by a spring-loaded pawl that is urged to engage the ratchet wheel under the force of the biasing member that engages the locking member. The locking assembly further includes an electrically activated retaining device to retain the locking member in the second position such that the locking member is prevented from rotating and engaging the ratchet wheel under the force of the biasing member.

The locking member is shiftable by rotation between the first position, in which the locking member engages the ratchet wheel such as to lock the ratchet wheel in one rotational direction, and the second position, in which the ratchet wheel is free to rotate relative to the locking member in both rotational directions. The electrically activated retaining device is arranged to retain the locking member in the second position. The biasing member is configured to move the locking member into the first position.

A ratchet is generally understood as a mechanical device that allows continuous rotary motion in only one direction while preventing/restricting motion in the opposite direction. A ratchet comprises a round gear with teeth (ratchet wheel). A pivoting, spring-loaded finger called a pawl engages the teeth. The teeth are uniform but asymmetrical, with each tooth having a moderate slope on one edge (tooth back) and a much steeper slope on the other edge (tooth face).

When the teeth are moving in the unrestricted direction, the pawl easily slides up and over the gently sloped edges of the teeth (back of teeth), with the spring forcing it into the depression between the teeth as it passes the tip of each tooth. When the teeth move in the opposite direction, however, the pawl will catch against the steeply sloped edge of the first tooth (tooth face) it encounters, thereby locking it against the tooth and preventing any further motion of the ratchet wheel in that direction. Hence, the ratchet wheel may be assigned a rotational locking direction and a rotational free-wheeling direction opposite to the locking direction. In the locking direction the locking assembly is arranged to lock the ratchet wheel against rotation. In the freewheeling direction, the ratchet wheel allows the locking member to ride over the teeth and rotation of the ratchet wheel in said freewheeling direction.

The combination of a biasing member that urges the locking member into engagement with the ratchet wheel and an electrically activated retaining device to prevent the biasing member from urging the locking member into engagement with the ratchet wheel allows for an energy-efficient shifting of the locking member in a fast and reliable manner. By providing a rotating locking member, only a small movement of the locking member to lock the ratchet wheel is necessary. Further, there is low impact sound when the locking member is switched.

The biasing member may be provided in the form of a tension spring or a pressure spring (attached to an arm of the locking member) or in the form of a rotational spring that rotationally biases the locking member.

According to a further embodiment of the invention, the locking member is provided in the form of a double ended lever with a first lever arm and a second lever arm, wherein the biasing member is applied to the first lever arm and the second lever arm is adapted to engage the locking track. According to yet a further embodiment, the electrically activated retaining device preferably directly acts on the second arm so that forces (biasing member and electrically activated retaining device) act on different sides of the locking member in relation to the rotational support. Preferably, the locking member is rotationally supported in a section between the first and the second lever arm.

According to yet a further embodiment, the first lever arm is shorter than the second lever arm. Thereby, a transmission ratio is achieved. The shifting movement of the first lever arm to bring the locking member into engagement with the ratchet wheel such as to lock the latter against rotation is smaller than the shifting movement of the second arm to engage the ratchet wheel. A fast shifting of the locking member into the second position is achieved.

According to a further embodiment of the invention, the electrically activated retaining device comprises electromagnetic means arranged to magnetically interact with the locking member to retain the locking member against rotation in the second position, e.g., an electro magnet. Preferably, the locking member is provided in the form of a double ended lever (as indicated above) with a first lever arm and a second lever arm, wherein the biasing member is applied to the first lever arm and the second lever arm is adapted to engage the locking track and the electromagnetic means is arranged to magnetically interact with the second lever arm. It only requires interruption of electric power supply to the electrically activated retaining device to release the locking member (second lever arm) such that the locking member rotates and engages the ratchet wheel. The electromagnetic means may comprise a coil to generate a magnetic field upon energization. Preferably, the locking member or at least part thereof (e.g., the second lever arm) is made of a ferrous material so that the electrically activated retaining device can retain the locking member in the second position.

According to a further embodiment of the invention, the ratchet wheel is configured such that when the support of electrical power to the electrically activated retaining device (e.g., electromagnetic means) is interrupted, rotation of the ratchet wheel in one direction is allowed while rotation in the opposite direction is prevented by the locking member.

According to a further embodiment of the invention, the ratchet wheel is arranged such that rotation the ratchet wheel (i.e., in the freewheeling direction) moves the locking member toward the electrically activated retaining device, and preferably into the second position. For that purpose, the ratchet wheel may comprise a number of teeth, with each tooth may have a moderate slope on one edge (back) and a much steeper slope on the other edge (front). The locking assembly may be arranged such that the back of the single tooth pushes the locking member away from the rotational center of the ratchet wheel toward the electrically activated retaining device. Preferably, the locking member is pushed into or at least moved close to the second position such that it may be retained in the second position or attracted(pulled) into the second position and retained in the second position by supplying electrical power to the electrically activated retaining device. Hence, the forces to pre-stress the biasing member are provided by the ratchet wheel which is very efficient in terms of energy consumption. In the case of a locking member in the form of a double-ended lever, the ratchet wheel moves the second lever arm toward the electrically activated retaining device against the force of the biasing member that is applied to the first lever arm.

According to a further embodiment of the invention, the locking assembly comprises a mounting bracket, wherein the locking member is rotationally supported on the mounting bracket, and wherein the electrically activated retaining device and the biasing member are each mounted on the mounting bracket such that the locking assembly can be installed in the form of a preassembled unit. This embodiment is not only cost effective but is easy to install.

According to a further embodiment of the invention, the locking member is a preferably stamped latch. A light locking member provides benefits in terms of reduced current consumption. Preferably, the locking member and the bracket are made of steel or other ferrous material. Alternatively, the bracket is not made of steel or other ferrous material and in accordance with another embodiment of the invention, the bracket is of a non-ferrous material such as plastic, but is provided with a ferrous element, such as a pin, that is arranged to function as the core of an electromagnet.

According to another embodiment of the invention, the locking track includes two oppositely oriented ratchets wheels and the shifter assembly comprises two locking assemblies, each assigned to one of the ratchet wheels. Hence, one of the locking assemblies may lock the actuation element against rotation in clockwise direction and the other locking assembly may lock the actuation element against rotation in counterclockwise direction.

According to yet a further embodiment of the invention, the shifter assembly is connected to a control unit to control actuation of the electromagnet means of each of the locking assemblies, wherein the control unit is configured such that the electrically activated retaining devices of the locking assemblies can be activated independently from each other. An efficient restriction of the possible movement of the shifter can be achieved in different rotational positions.

The invention further relates a motor vehicle comprising a shifter assembly as described herein.

The foregoing advantages as well as other advantages of various aspects of the present invention will become apparent to those of ordinary skill in the art by reading the following detailed description, with appropriate reference to the accompanying drawings, in which

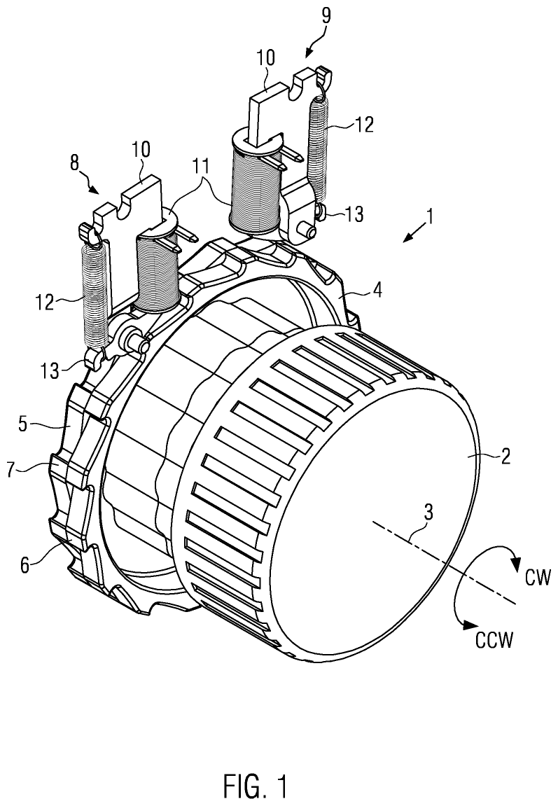

FIG. 1 a shifter assembly in accordance with a first embodiment of the invention;

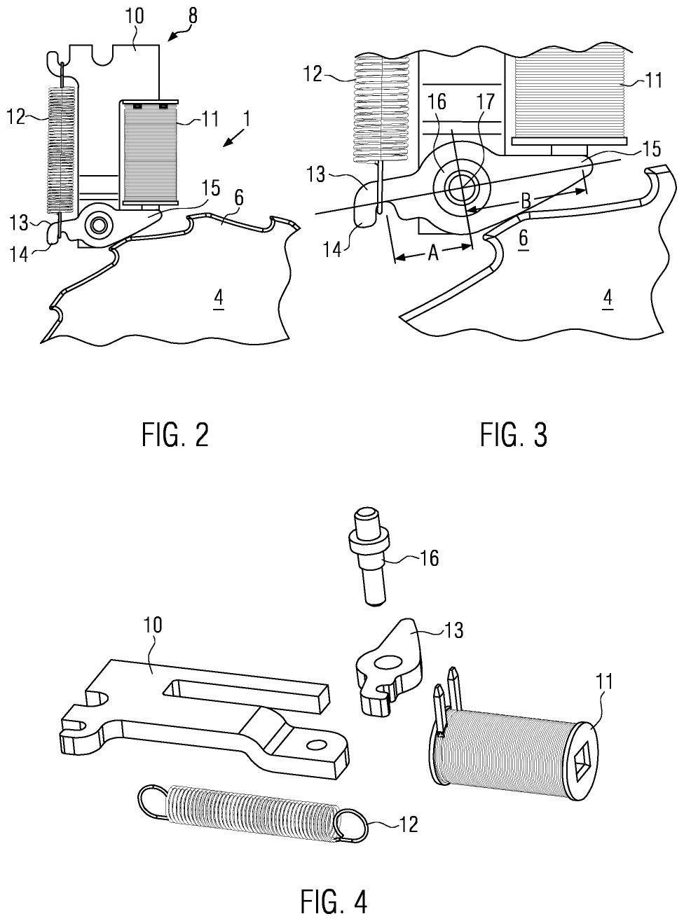

FIG. 2 parts of the shifter assembly of FIG. 1;

FIG. 3 a detailed view of FIG. 2;

FIG. 4 components of the shifter assembly of FIG. 1; and

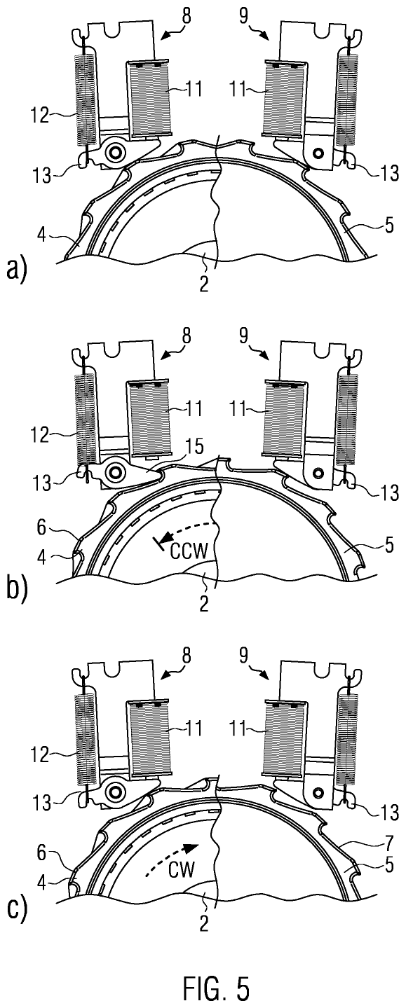

FIG. 5a-c the shifter assembly of FIG. 1 in different states.

FIG. 1 shows a shifter assembly 1 for controlling the transmission of a motor vehicle. The shifter assembly 1 comprises a rotatably mounted actuation element 2 in the form of a knob that is rotatable for the selection of a shift stage such as Park (P), Drive (D), Neutral (N) and Reverse (R) about a rotational axis 3 in clockwise (CW) direction and in counterclockwise (CCW) direction. The actuation element 2 is provided with a locking track having a plurality of locking projections. The locking track is provided by a first ratchet wheel 4 and a second ratchet wheel 5 located adjacent the first ratchet wheel 4, each of the ratchet wheels 4, 5 being firmly connected to the actuation element 2.

The locking track serves to lock the actuation element 2 against rotation in counterclockwise direction and/or clockwise direction. The ratchet wheels 4, 5 are each provided with a number of teeth 6, 7, wherein the teeth of the first and second ratchet wheels 4, 5 are oriented in opposite circumferential directions. The teeth are formed asymmetrical and have an inclined back and a much steeper front. The front of the teeth 6 of the first ratchet wheel 4 is oriented in counterclockwise direction, whereas the front of the teeth 7 of the second ratchet wheel 5 is oriented in clockwise direction.

In order to lock the actuation element 2 against rotation in clockwise and counterclockwise direction, a first locking assembly 8 and a second locking assembly 9 are provided. The locking assemblies 8 and 9 are basically identical in construction but are oriented in opposite direction, i.e., the second locking assembly 9 showing its back is turned 180° relative to the first locking assembly 8 showing its front. The locking assemblies 8,9 each comprise a mounting bracket 10 made of sheet metal, a coil 11 which may be energized with electrical power and a coil spring 12 (tension spring). At a lower end of the mounting bracket 10 a locking member 13 in the form of a latch is rotatably supported on the mounting bracket 10.

The first locking assembly 8 is arranged substantially above the first ratchet wheel 4 and the second locking assembly 9 is arranged substantially above the second ratchet wheel 5. The locking member 13 of the first locking assembly 8 is configured to engage the teeth 6 of the first ratchet wheel 4 and to lock the first ratchet wheel 6 against rotation in counterclockwise (CCW) direction and the second locking assembly 9 is configured to engage the teeth 7 of the second ratchet wheel 5 and lock the second ratchet wheel 5 against rotation in clockwise (CW) direction.

FIG. 2 shows in detail the first locking assembly 8 in FIG. 1 and the interaction with the first ratchet wheel 4 of the shifter assembly. FIG. 3 is an enlarged view of the locking member 13 in FIG. 2. The locking member 13 is provided in the form of a double ended lever with a first lever arm 14 and a second lever arm 15. In a center section connecting the first lever arm 14 and the second lever arm 15, the locking member 13 is provided with a through opening to receive a latch shaft or mounting shaft 16 to mount the locking member 13 on the mounting bracket 10 such that the locking member 13 may pivot about a center of rotation 17.

The locking member 13 is rotatable between a first position in which the second lever arm 15 engages the front of the teeth 6 of the first ratchet wheel 4 and locks the first ratchet wheel against counterclockwise rotation and a second position (shown in FIG. 3) in which the second lever arm 15 is disengaged from the first ratchet wheel 4 and the first ratchet wheel 4 is free to rotate in counterclockwise direction.

The biasing member 12 in the form of a spring is attached to the first lever arm 14 at a distance ‘A’ from the center of rotation 17. The coil 11 is arranged such as to magnetically interact with the second lever arm 15. When energized, the coil 11 generates magnetic pulling forces acting on the second lever arm 15 at a distance ‘B’ from the center of rotation 17. The first lever arm 14 is shorter than the second lever arm 15 (‘A’<‘B’). When the coil is energized and the locking member 13 is in the second position as shown in FIGS. 2 and 3, the coil acts as an electrically activated retaining device that retains the locking member 14 in the second position such that the locking member 13 is prevented from rotating and engaging the ratchet wheel 4 under the force of the biasing member 12. The second locking assembly 9, which interacts with the second ratchet wheel 5, is constructed correspondingly.

FIG. 4 shows the components of the locking assemblies 8, 9 in a disassembled condition. The mounting bracket 10 is provided in the form of a sheet metal bracket that is stamped and therefore easy and cost-effective to manufacture. On a side section of the sheet metal bracket 10, an elongated bar receives the center section of the coil 11. On the opposite side of the mounting bracket 10, the spring 11 is to be attached. The mounting shaft 16 is to be inserted in a hole in the locking member 13 and into a hole at the forward end of the mounting bracket 10 thereby rotatably mounting the locking member 13 on the mounting bracket.

FIG. 5a-5c shows part of the shifter assembly of FIG. 1 with the first and second ratchet wheel 4 and 5. The curved line in the middle of the wheels indicates that the right half of the first ratchet wheel 4 is not shown to expose the right half of the second ratchet wheel 5 lying behind the first ratchet wheel 4. As evident from the direction of the teeth of the first and second ratchet wheel, the teeth of the first ratchet wheel 4 and the teeth of the second ratchet wheel 5 are oriented in opposite directions.

FIGS. 5a - 5c illustrate the actuation of the locking assemblies 8, 9 to lock the shifter assembly against counterclockwise rotation of the actuation element 2.

In FIG. 5a, the coil 11 of the first locking assembly 8 and the coil of the second locking assembly 9 are both supplied with electrical power. Both locking members 13 are in their respective second position and retained in that position by the magnetic field generated by the respective coil. The actuation element 2 is free to rotate clockwise and counterclockwise direction.

In FIG. 5b, power supply to the first locking assembly 8 is interrupted so that the coil 11 of the first locking assembly 8 does not produce a magnetic field and does not retain the respective locking member 13 in its second position. The locking member 13 of the first locking assembly 8 may now rotate under the force of the spring 12 such that its second lever arm 15 may engage the teeth 6 of the first ratchet wheel 4. When the teeth 6 are moving in the restricted direction (counterclockwise direction), the spring 12 forces the locking member 13 into the depression between adjacent teeth. Upon further rotation in counterclockwise direction, the second lever arm 15 will catch against the face-side sloped edge of the next tooth (as shown in FIG. 5b) thereby locking the first ratchet wheel 4 against further rotation in the counterclockwise (CCW) direction. Rotation in the opposite direction (clockwise direction), however, is possible, because of the activated second locking assembly 9.

In FIG. 5c, the first locking assembly 8 remains unpowered and the second locking assembly 9 remains powered, which corresponds to the state in FIG. 5b. The user now rotates the actuation element 2 in clockwise direction. The locking member 13 of the second locking assembly 9 cannot catch the teeth 7 on the second ratchet wheel 5, because it is retained in the second position.

At the same time, the locking member 13 of the first locking assembly 8 is rotatable and is constantly forced against the first ratchet wheel 4 by the spring 12 of the first locking assembly 8. However, in clockwise direction, the locking member 13 of the first locking assembly 8 will ride over the teeth 6 of the first ratchet wheel 4, wherein the teeth do not provide an edge for the locking member to catch and lock the first ratchet wheel 4.

In order to lock the shifter assembly in clockwise direction, a control unit (not shown) interrupts power to the coil 11 of the second locking assembly 9, so that the locking member 13 of the second locking assembly 9 may rotate under the force of the spring such that its second lever arm engages the front end of the teeth of the second ratchet wheel 5.

### REFERENCE NUMERALS

1 shifter assembly
2 actuation element
3 rotational axis
4 first ratchet wheel
5 second ratchet wheel
6 teeth of first ratchet wheel
7 teeth of second ratchet wheel
8 first locking assembly
9 second locking assembly
10 mounting bracket
11 coil
12 spring
13 locking member
14 first lever arm
15 second lever arm
16 mounting shaft
17 center of rotation

1. A shifter assembly for controlling the transmission of a vehicle comprising:
a rotatably mounted actuation element that is rotatable for selection of a shift stage; and
at least one locking assembly configured to lock the actuation element against rotation,
wherein the actuation element is provided with a locking track having a plurality of locking projections, wherein the locking track is provided on the circumference of a ratchet wheel connected to the actuation element;
wherein the locking assembly includes at least one locking member that is rotatable about a rotational axis between a first position in which the locking member engages the locking track such as to lock the ratchet wheel and the actuation element against rotation in at least one rotational direction and a second position in which rotation of the ratchet wheel and the actuation element in the one rotational direction is allowed,
wherein the locking assembly includes:
a biasing member applied to the locking member to rotationally bias the locking member into the first position; and
an electrically activatable retaining device to retain the locking member in the second position when electrically activated such that the locking member is prevented from rotating and engaging the ratchet wheel under the force of the biasing member;
wherein the ratchet wheel is configured such that when the locking member is in the first position, rotation of the ratchet wheel in a rotational direction opposite to the one rotational direction moves the locking member toward the electrically activatable retaining device and into the second position or at least close to the second position such that it may be retained in the second position or attracted into the second position and retained in the second position by supplying electrical power to the electrically activatable retaining device.

2. The shifter assembly according to claim 1, wherein the locking member is provided in the form of a double ended lever with a first lever arm and a second lever arm, wherein the biasing member is applied to the first lever arm and the second lever arm is adapted to engage the locking track.

3. The shifter assembly according to claim 2, wherein the first lever arm is shorter than the second lever arm.

4. The shifter assembly according to claim 1, wherein the electrically activatable retaining device comprises electromagnetic means arranged to magnetically interact with the locking member.

5. (canceled)

6. The shifter assembly according to claim 1, wherein the locking assembly comprises a mounting bracket, wherein the locking member is rotationally supported on the mounting bracket, and wherein the electrically activatable retaining device and the biasing member are each mounted on the mounting bracket such that the locking assembly can be installed in the form of a preassembled unit.

7. The shifter assembly according to claim 1, wherein the biasing member is a tension spring, a pressure spring or a rotational spring.

8. The shifter assembly according to claim 1, wherein the locking member is a stamped latch.

9. The shifter assembly according to claim 1, wherein the locking assembly includes two oppositely oriented ratchet wheels and wherein the shifter assembly comprises two locking assemblies, each assigned to one of the ratchet wheels.

10. The shifter assembly according to claim 9, wherein the shifter assembly is connected to a control unit to control actuation of the electrically activatable retaining devices, wherein the control unit is configured such that the electrically activatable retaining devices can be activated independently from each other.

11. A vehicle having a transmission, the vehicle comprising:
a shifter assembly for controlling the transmission, the shifter assembly comprising;
a rotatably mounted actuation element that is rotatable for selection of a shift stage, and
at least one locking assembly configured to lock the actuation element against rotation,
wherein the actuation element is provided with a locking track having a plurality of locking projections, wherein the locking track is provided on the circumference of a ratchet wheel connected to the actuation element;
wherein the locking assembly includes at least one locking member that is rotatable about a rotational axis between a first position in which the locking member engages the locking track such as to lock the ratchet wheel and the actuation element against rotation in at least one rotational direction and a second position in which rotation of the ratchet wheel and the actuation element in the one rotational direction is allowed,
wherein the locking assembly includes:
a biasing member applied to the locking member to rotationally bias the locking member into the first position; and
an electrically activatable retaining device to retain the locking member in the second position when electrically activated such that the locking member is prevented from rotating and engaging the ratchet wheel under the force of the biasing member;
wherein the ratchet wheel is configured such that when the locking member is in the first position, rotation of the ratchet wheel in a rotational direction opposite to the one rotational direction moves the locking member toward the electrically activatable retaining device and into the second position or at least close to the second position such that it may be retained in the second position or attracted into the second position and retained in the second position by supplying electrical power to the electrically activatable retaining device.

12. The vehicle according to claim 11, wherein the locking member is provided in the form of a double ended lever with a first lever arm and a second lever arm, wherein the biasing member is applied to the first lever arm and the second lever arm is adapted to engage the locking track.

13. The vehicle according to claim 12, wherein the first lever arm is shorter than the second lever arm.

14. The vehicle according to claim 11, wherein the electrically activatable retaining device comprises electromagnetic means arranged to magnetically interact with the locking member.

15. The vehicle according to claim 11, wherein the locking assembly comprises a mounting bracket, wherein the locking member is rotationally supported on the mounting bracket, and wherein the electrically activatable retaining device and the biasing member are each mounted on the mounting bracket such that the locking assembly can be installed in the form of a preassembled unit.

16. The vehicle according to claim 11, wherein the biasing member is a tension spring, a pressure spring or a rotational spring.

17. The vehicle according to claim 11, wherein the locking member is a stamped latch.

18. The vehicle according to claim 11, wherein the locking assembly includes two oppositely oriented ratchet wheels and wherein the shifter assembly comprises two locking assemblies, each assigned to one of the ratchet wheels.

19. The vehicle according to claim 18, wherein the shifter assembly is connected to a control unit to control actuation of the electrically activatable retaining devices, wherein the control unit is configured such that the electrically activatable retaining devices can be activated independently from each other.
